(19) United States
(12) Patent Application Publication
(10) Pub. No.: US 2026/0298024 A1
(43) Pub. Date: Oct. 1, 2026

(54) GATE FRAME SUSPENDED ON OVERHEAD BEAM ASSEMBLED FROM MODULAR FRAME ELEMENTS

(71) Applicant: Secure Orbit Inc., Thunder Bay (CA)

(72) Inventor: Tyler Bragnalo, Thunder Bay (CA)

(21) Appl. No.: 19/095,251

(22) Filed: Mar. 31, 2025

(51) Int. Cl. E06B 11/04; E06B 11/02

(52) U.S. Cl. CPC E06B 11/045; E06B 11/026

(57) ABSTRACT

A gate assembly includes a stationary frame supporting a gate frame thereon for translating movement between open and closed positions relative to a gate opening. The stationary frame includes post assemblies at opposing sides of the gate opening and an overhead beam spanning over the gate opening between the post assemblies from which the gate frame is suspended. The overhead beam and the gate frame are modular assemblies formed of frame elements joined to one another by threaded fasteners. In this manner, the components of the gate assembly can be shipped as a package having shipping dimensions which are greatly reduced relative to the assembled dimensions of the gate assembly so that the package can be transported more easily and at reduced cost.

### FIELD OF THE INVENTION

The present invention relates to a gate assembly including a gate frame supported for translating movement along an overhead beam relative to a gate opening, and more particularly the present invention relates to a gate frame and/or overhead beam formed of modular frame elements coupled by threaded fasteners.

### BACKGROUND

A common gate assembly construction for supporting a gate frame for translating movement across a gate opening between open and closed positions includes an overhead beam spanning across the gate opening from which the gate frame is suspended. The overhead beam and the gate frame are typically manufactured using welded frame members to ensure sufficient strength for security applications; however, the overhead beam is typically twice the length of the gate opening to support the gate frame in the open position such that it can be difficult and costly to ship the overhead beam from a manufacturing location to the installation location of the gate assembly.

### SUMMARY OF THE INVENTION

According to one aspect of the invention there is provided a gate assembly comprising:

a first post assembly and a second post assembly arranged to be supported in fixed relation to ground at longitudinally spaced apart locations so as to define a gate opening spanning in a longitudinal direction between the first post assembly and the second post assembly;

an overhead beam arranged to be mounted on the first post assembly and the second post assembly so as to span in the longitudinal direction over the gate opening; and

a gate frame arranged to be suspended from the overhead beam for translating movement in the longitudinal direction along the overhead beam between a closed position spanning the gate opening between the first post assembly and the second post assembly and an open position in which the gate opening is at least partially unobstructed by the gate frame;

wherein at least one of the overhead beam and the gate frame comprises a modular assembly of frame elements joined to one another by threaded fasteners whereby the modular assembly is reduced in length in the longitudinal direction when the frame elements are disassembled relative to one another.

Each of the overhead beam and the gate frame being formed of modular frame elements enables the gate assembly to be shipped as a package having shipping dimensions which are greatly reduced relative to the assembled dimensions of the gate assembly so that the package can be transported more easily and at reduced cost.

Preferably the modular assembly is part of the modular assembly, in which the frame elements of the modular assembly comprise (i) a top rail formed in top rail sections mounted longitudinally end to end, (ii) a bottom rail formed in bottom rail sections mounted longitudinally end to end, and (iii) a plurality of struts fastened between the top rail and the bottom rail.

The struts of the overhead beam may comprise plate members mounted externally at opposing sides of the top rail and the bottom rail at longitudinally spaced positions.

When each adjacent pair of the top rail sections forms a top rail junction, and each adjacent pair of the bottom rail sections forms a bottom rail junction, preferably the top rails sections of each top rail junction and the bottom rail sections of each bottom rail junction are joined by a pair of the plate members forming the struts which span across the top rail junction and the bottom rail junction.

The gate assembly preferably includes at least one top coupling member joined between each adjacent pair of the top rail sections so as to longitudinally overlap each of the top rail sections of the adjacent pair, and at least one bottom coupling member joined between each adjacent pair of the bottom rail sections so as to longitudinally overlap each of the bottom rail sections of the adjacent pair.

Each of the top rail sections and bottom rail sections may be an extruded profile, in which said at least one top coupling member comprises a pair of plate members mounted parallel and spaced apart from one another at laterally opposing sides of the top rail sections, and in which said at least one bottom coupling member comprises a pair of plate members mounted parallel and spaced apart from one another at laterally opposing sides of the bottom rail sections.

The plate members forming the top and bottom coupling members are preferably mounted internally within the extruded profiles of the top rail sections and bottom rail sections.

The modular assembly preferably also includes the gate frame in which the frame elements of the modular assembly comprise (i) a top rail formed in top rail sections mounted longitudinally end to end, (ii) a bottom rail formed in bottom rail sections mounted longitudinally end to end, (iii) an intermediate rail formed in intermediate rail sections mounted longitudinally end to end, (iv) a plurality of posts formed in post sections mounted vertically end to end, and (v) a plurality of gate connectors mounted at respective junctions of the post sections with the rail sections.

Preferably each post section and each rail section of the gate frame comprises a tubular member, in which each gate connector includes (i) at least one post leg arranged to be vertically slidable into the tubular member of a respective one of the post sections and (ii) at least one rail leg arranged to be longitudinally slidable into the tubular member of a respective one of the rail sections.

The gate assembly may further include a plurality of auxiliary rail sections different in length from the top rail sections, the bottom rail sections and the intermediate rail sections, in which the auxiliary rail sections are interchangeable with the top rail sections, the bottom rail sections and the intermediate rail sections.

The gate frame preferably further comprises a plurality of diagonal struts connected between respective ones of the gate connectors, in which the diagonal struts extend transversely to the post sections and the rail sections. The diagonal struts are preferably connected to the respective gate connectors by pivotal connections such that an angular orientation of each diagonal strut relative to the post sections is adjustable according to a selected length of the rail sections.

When each post section and each rail section of the gate frame comprises a tubular member and the gate frame further comprises a plurality of diagonal struts connected between respective ones of the gate connectors, preferably some of the gate connectors comprise intermediate gate connectors, in which each intermediate gate connector comprises: (i) two post legs arranged to be vertically slidable into the tubular members of two post sections above and below the intermediate gate connector respectively; (ii) two rail legs arranged to be longitudinally slidable into the tubular members of two rail sections at longitudinally opposed sides of the intermediate gate connector; and (iii) four pivotal connections pivotally coupling respective ones of the diagonal struts thereon to extend transversely to the post and rail sections at circumferentially spaced locations about the intermediate gate connector.

When the bottom rail sections comprise tubular members, the bottom rail may further comprise a pair of side plates mounted along laterally opposing sides of the tubular members so as to define a bottom roller channel along a bottom side of the bottom rail, the bottom roller channel receiving at least one bottom roller rotatable therein.

The gate assembly may further comprise at least one bottom roller guide arranged to be received within a bottom roller channel extending along a bottom side of the gate frame, in which said at least one bottom roller guide comprises: (i) a rocker member pivotally supported about an upright pivot axis; (ii) a pair of bottom rollers supported for rotation about respective upright roller axes at opposing ends of the rocker member; and (iii) an adjustment member arranged to urge pivotal rotation of the rocker member in direction to increase an overall width defined by the pair of bottom rollers in a lateral direction transversely to the longitudinal direction of the gate frame.

The gate frame may further comprise a top roller carriage supported at each junction between adjacent ones of the top rail sections, in which each top roller carriage is supported in rolling engagement along the overhead beam.

When the first post assembly receives a terminal end of the gate frame engaged thereon in the closed position of the gate, the first post assembly preferably includes a plurality of gate receiving sockets formed thereon at vertically spaced locations, in which each gate receiving socket includes (i) a pair of parallel socket walls receiving the gate frame therebetween and (ii) a pair of tapered guide walls sloped laterally inwardly towards one another and towards the parallel socket walls so to be arranged to guide the gate frame between the parallel socket walls as the gate frame is displaced towards the closed position.

When the gate frame comprises an end post at the terminal end of the gate frame which is arranged to be received within the gate receiving sockets, the end post may further comprise wear members covering the end post and engaging the parallel socket walls and the tapered guide walls of the gate receiving sockets in the closed position.

### BRIEF DESCRIPTION OF THE DRAWINGS

One embodiment of the invention will now be described in conjunction with the accompanying drawings in which:

FIG. 1 is a perspective view of a first side of the gate assembly;

FIG. 2 is a perspective view of a second side of the gate assembly opposite to FIG. 1;

FIGS. 3 and 4 are enlarged perspective views of an upper portion of a first post assembly at a first end of the gate assembly of FIG. 1;

FIG. 5 is an enlarged perspective view of an upper portion of a post assembly at a second end of the gate assembly of FIG. 1;

FIG. 6 is sectional view of the overhead beam of the gate assembly of FIG. 1, shown sectioned along a lateral plane;

FIG. 7 is sectional view of the overhead beam of the of the gate assembly of FIG. 1, shown sectioned along a longitudinal plane;

FIG. 8 is an enlarged perspective view of a lower portion of the gate assembly of FIG. 1;

FIG. 9 is a sectional view of a lower portion of the gate frame of the gate assembly of FIG. 1, showing drive components and bottom roller guides of the gate frame;

FIG. 10 is a perspective view of a lower portion of the gate assembly of FIG. 1, showing the bottom roller guides with the gate frame removed for illustrative purposes;

FIG. 11 is a perspective view of the gate frame of the gate assembly of FIG. 1, shown removed from the stationary frame;

FIG. 12 is a perspective view of a top roller carriage above one of the top rail junctions of the gate frame according to the gate assembly of FIG. 1;

FIG. 13 is another perspective view of the top roller carriage of FIG. 12 with some of the components of the gate frame removed for illustrative purposes;

FIG. 14 is a perspective view of an intermediate one of the connectors of the gate frame according to the gate assembly of FIG. 1;

FIGS. 15 and 16 are perspective views of the intermediate connector of FIG. 14, with some of the components of the gate frame removed for illustrative purposes; and

FIG. 17 is an enlarged perspective view of the upper portion of the gate assembly of FIG. 1, showing the first side of the gate assembly. In the drawings like characters of reference indicate corresponding parts in the different figures.

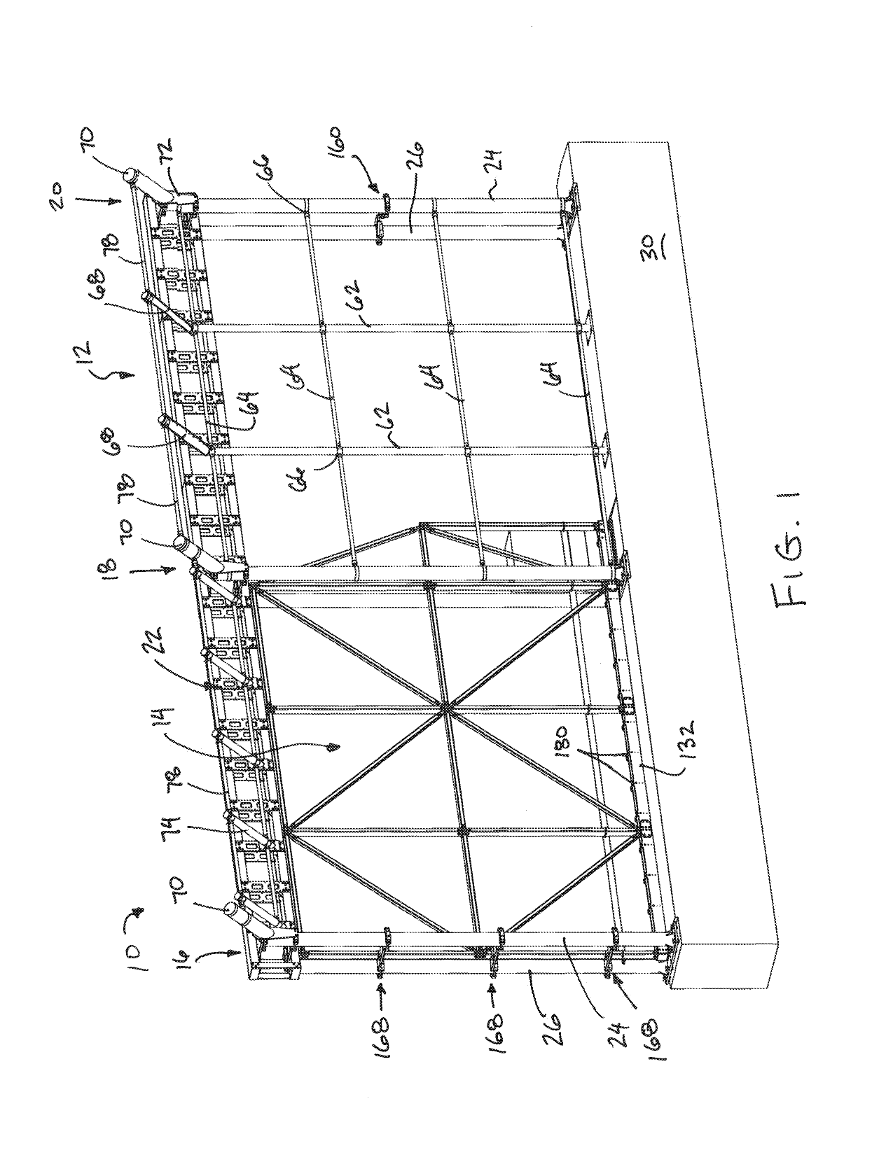

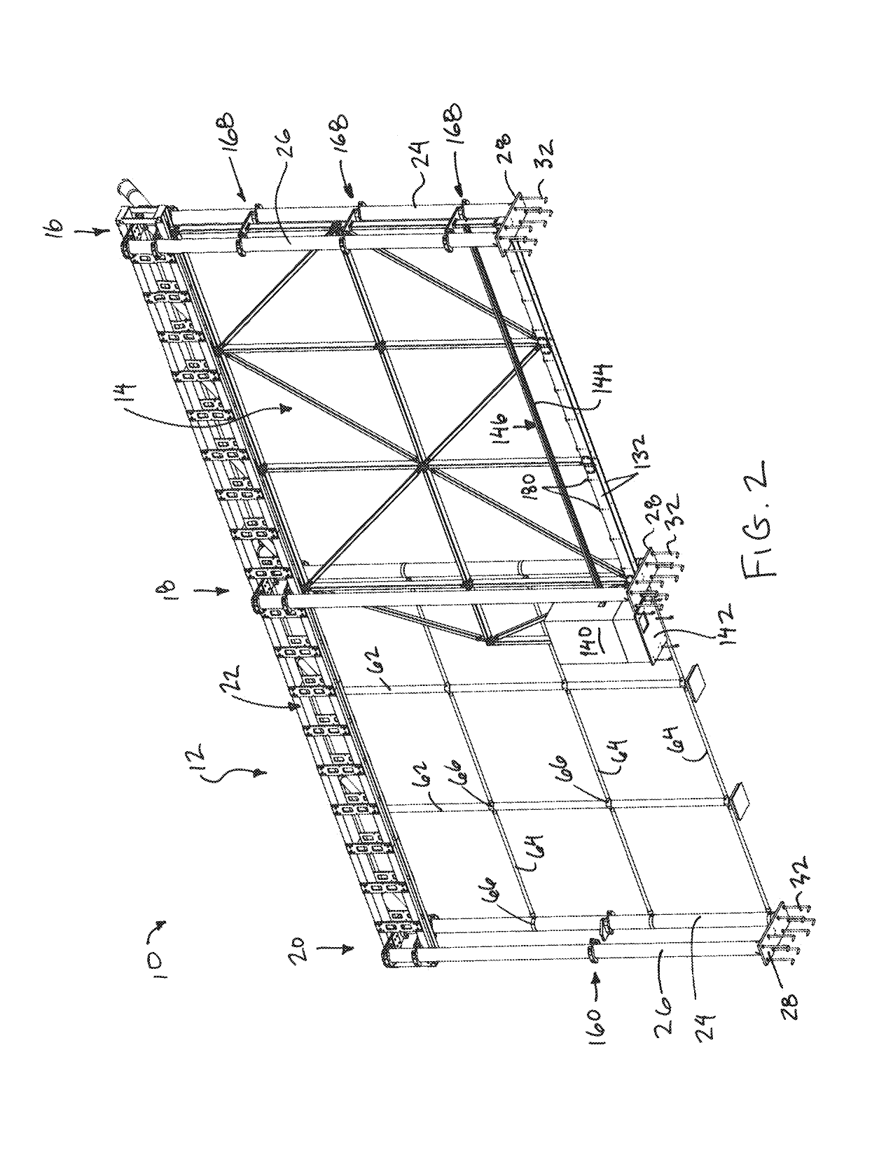

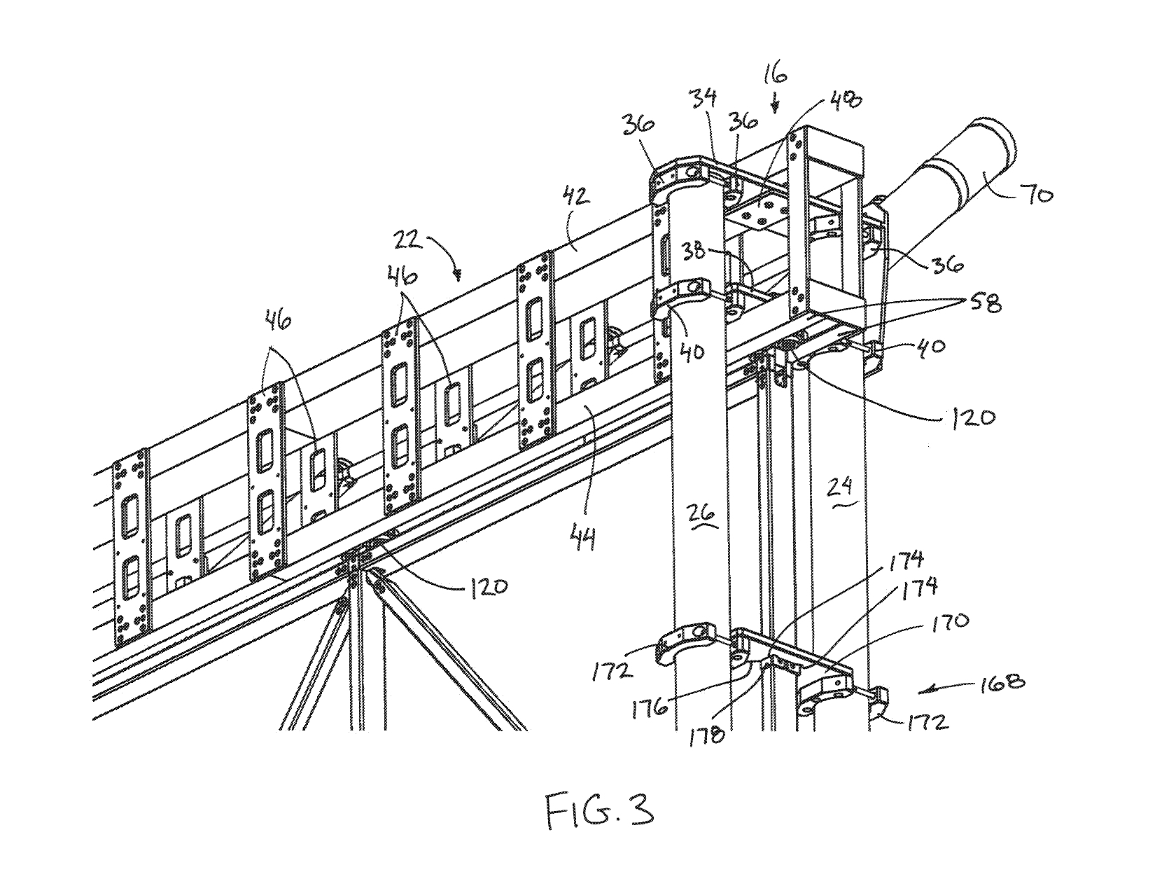

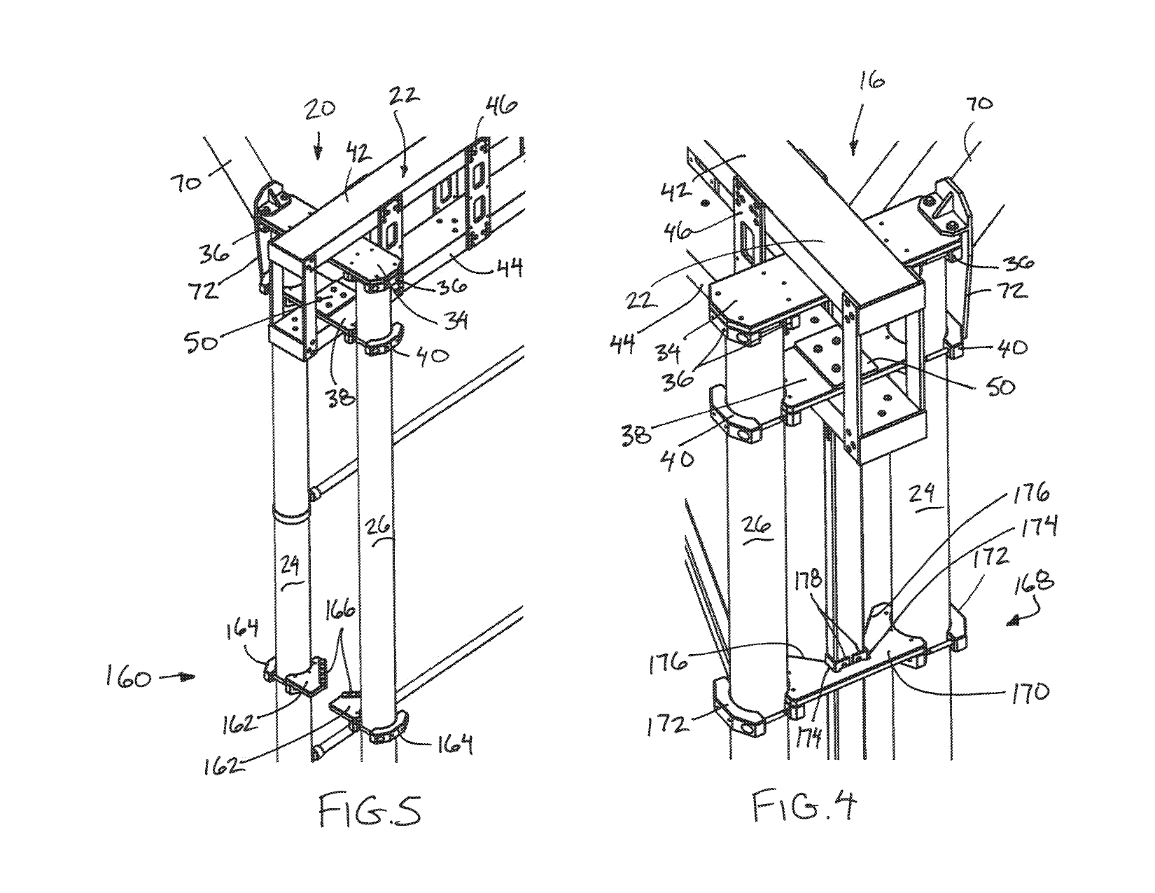

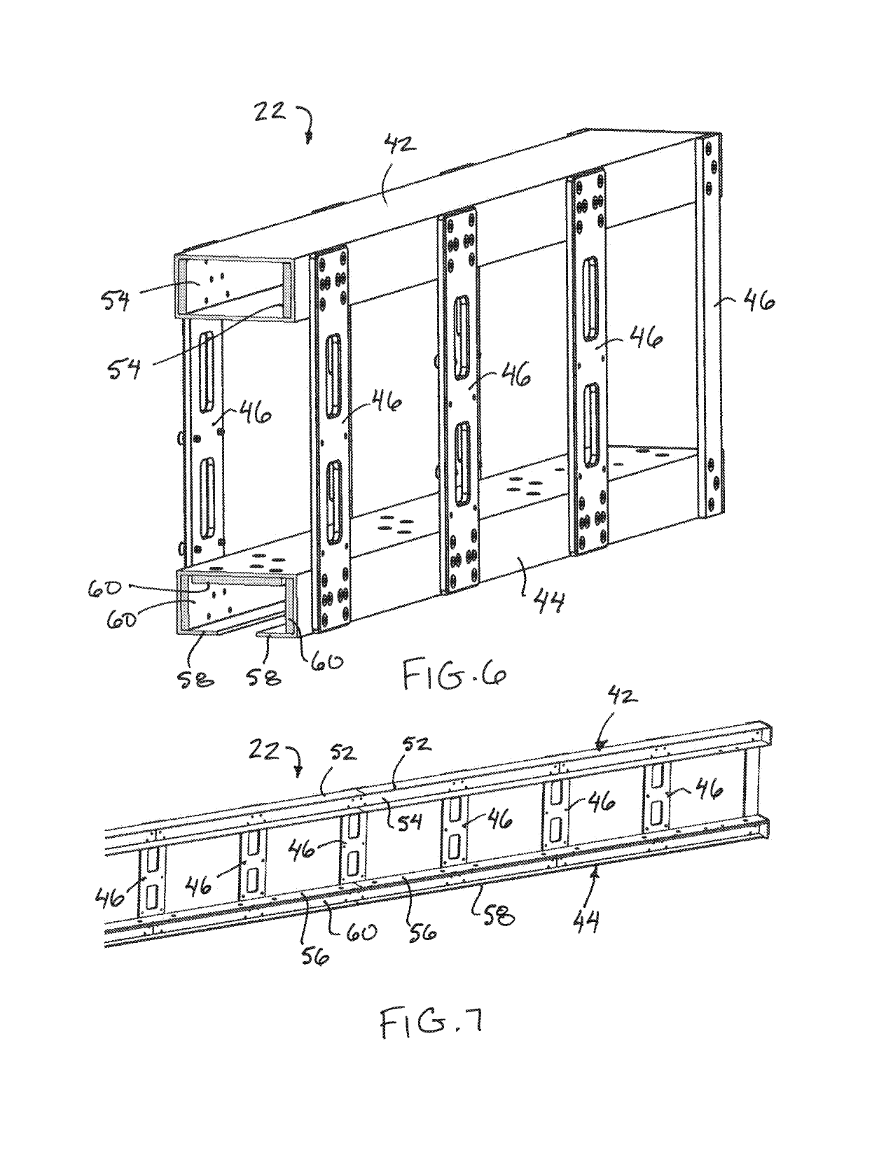

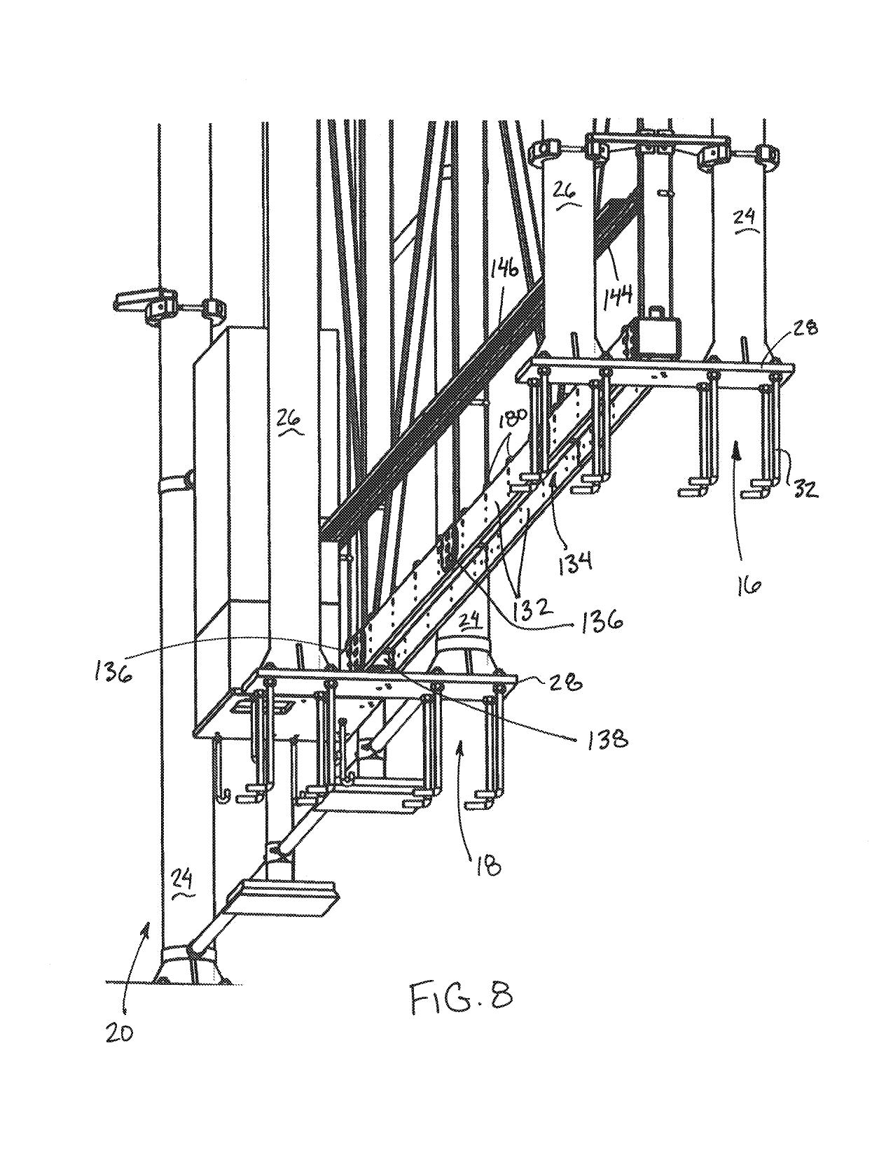

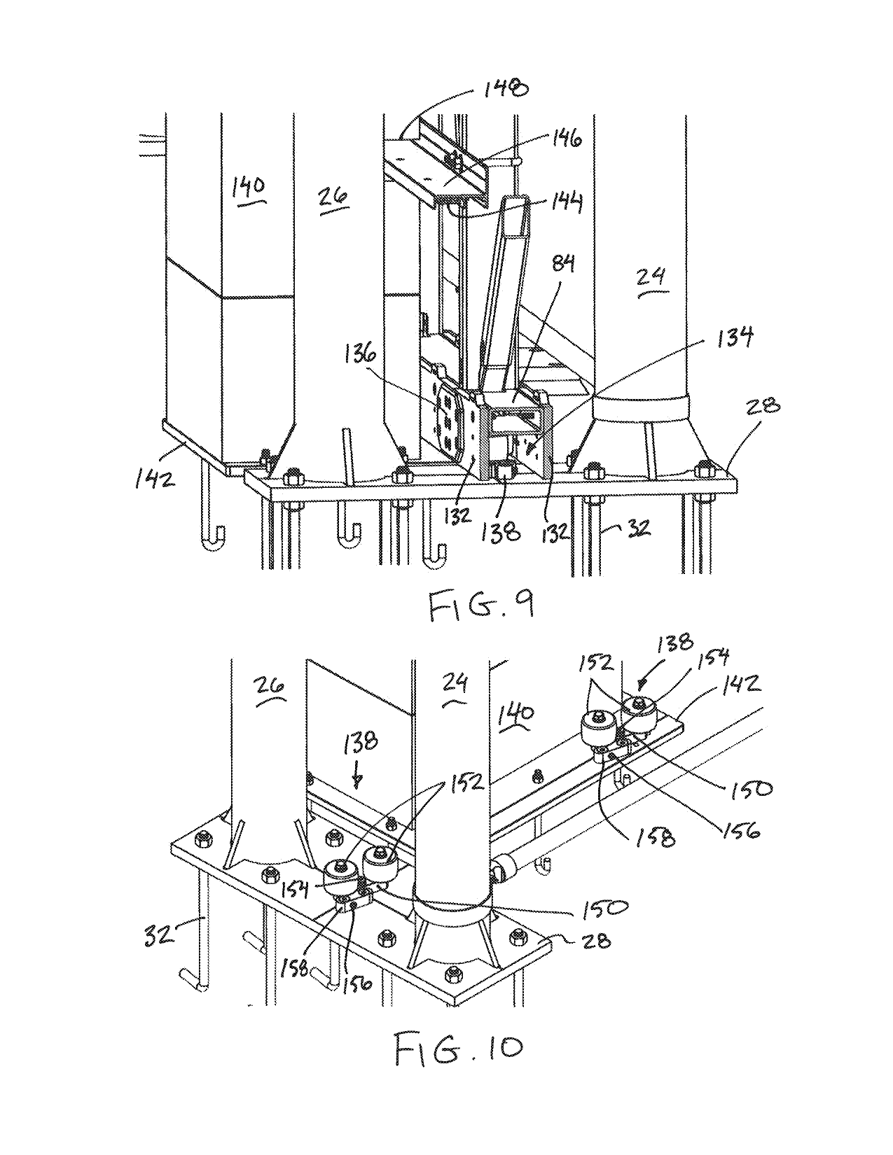

### DETAILED DESCRIPTION

Referring to the accompanying figures there is illustrated a gate assembly generally indicated by reference numeral 10. The gate assembly 10 is generally operable relative to a gate opening defined within a perimeter fence or wall structure surrounding an area to be secured for example.

In the following description, a first side of the gate assembly referred to as the inside is configured to restrict access to unauthorized persons, for example when used to prevent escape of unauthorized persons from a contained area. However, in other instances, the first side of the gate assembly that restricts access to unauthorized persons may be positioned at the outside of a structure being contained to prevent entry of unauthorized persons into the contained area.

In each instance, the gate assembly 10 generally includes a stationary frame 12 arranged to be fixed relative to the ground about the gate opening, and a gate frame 14 which is supported on the stationary frame 12 so as to be movable in a translating movement in a longitudinal direction of the gate opening between a closed position fully spanning the gate opening and an open position in which the gate opening is at least partly unobstructed by the gate frame to permit passage of persons or vehicles and the like through the gate opening.

The stationary frame 12 generally includes a first post assembly 16 and a second post assembly 18 mounted in fixed relation to the ground at longitudinally opposing ends of the gate opening in which the post assemblies are spaced apart in the longitudinal direction by a distance which is approximately equal or slightly less than a corresponding length of the gate frame 14 to enable the gate frame to fully span the gate opening between the first post assembly 16 and the second post assembly 18 in the closed position. A third post assembly 20 is similarly mounted in fixed relation to the ground in an upright orientation in a common longitudinal row with the first and second post assemblies by being spaced longitudinally from the second post assembly in an opposite direction from the first post assembly in which the longitudinal distance between the second and third post assemblies is approximately equal to the longitudinal distance between the first and second post assemblies so that the post assemblies are approximately evenly spaced in the longitudinal direction.

The post assemblies 16, 18 and 20 support an overhead beam 22 thereon to extend across the top of the post assemblies in fixed relation thereto such that the overhead beam spans across a full length of the gate assembly and across the top of the gate opening. Each of the first, second and third post assemblies 16, 18 and 20 are similarly configured to include an inside post 24 at the inside of the gate assembly and an outside post 26 at the outside of the gate assembly such that the posts are spaced apart in a lateral direction perpendicular to the longitudinal direction of the gate opening. The gap between the posts is arranged to be equal or greater than an overall thickness of the gate frame 14 in the lateral direction such that the gate frame can be received for longitudinal sliding movement between the inside post and the outside post of each post assembly.

Within each post assembly, the inside post 24 and the outside post 26 are joined together in fixed relation, for example by welding to a baseplate 28 arranged to be supported horizontally on the ground or a suitable foundation. In the illustrated embodiment, a foundation block 30 of concrete is poured into a rectangular trench or form in the ground such that the upper surface of the foundation block is substantially flush with surrounding ground such as a roadway aligned to pass through the gate opening. The baseplate 28 thus includes suitable apertures for receiving the threaded fasteners of embedded anchors 32 embedded in the foundation block so that the baseplate 28 can be fastened in fixed relation to the upper surface of the foundation block.

Each post assembly 16, 18 and 20 further includes a top member 34 in the form of a plate spanning horizontally in the lateral direction across the top of the inside post 24 and the outside post 26 to join the posts and set the lateral distance between the posts. A set of mounting blocks 36 are fastened under the plate of each top member 34 so that a pair of the mounting blocks 36 are clamped against laterally opposing sides of each of the inside post 24 and the outside post 26. Laterally extending fasteners are secured between the pair of mounting blocks 36 of each post to clamp the mounting blocks about the post and position the post relative to the top member 34 onto which the mounting blocks 36 are mounted.

Each post assembly 16, 18 and 20 further includes an intermediate member 38 spaced below the top member 34 by approximately the height of the overhead beam 22. The intermediate member 38 also comprises a plate extending horizontally in the lateral direction across the gap between the inside post 24 and the outside post 26 so that the intermediate member is parallel and spaced below the top member 34. Additional mounting blocks 40 are provided in pairs associated with each of the inside post 24 in the outside post 26 to be joined by laterally extending fasteners that clamp the mounting blocks 40 in the lateral direction about each of the inside post on the outside post. The plate forming the intermediate member 38 is fastened onto the innermost mounting block 40 of each pair so that the intermediate member 38 is mounted in fixed relation to the posts.

The overhead beam 22 is supported on the post assemblies by being fastened to the top member 34 and the intermediate member 38 of each post assembly. More particularly, the overhead beam comprises a modular assembly of a plurality of frame elements including a top rail 42 formed in modular sections to extend the full length of the beam at the top side of the beam, a bottom rail 44 formed in modular sections to extend the full length of the beam at the bottom side of the beam, and a plurality of struts 46 fastened between the modular sections of the top rail 42 and the bottom rail 44 at longitudinally spaced positions.

The top rail 42 is engaged upon the top member 34 of each post assembly and threaded fasteners are fastened upwardly through the top member 34 into the top rail 42 to fix the top rail relative to the post assemblies. An upper reinforcement plate 48 may be located below the top member 34 through which the fasteners are penetrated so that the reinforcement plate 48 clamps the top member 34 between the reinforcement plate and the underside of the top rail 42 at each post assembly.

The bottom rail 44 is engaged below the intermediate member 38 of each post assembly and threaded fasteners are fastened downwardly through the intermediate member 38 into the bottom rail to fix the bottom rail relative to the post assemblies. A lower reinforcement plate 50 is located above the intermediate member 38 of each post assembly through which the fasteners are penetrated so that the reinforcement plate 50 clamps the intermediate member between the reinforcement plate and the top side of the bottom rail 44 at each post assembly.

The top rail 42 is formed of a plurality of top rail sections 52 which are mounted end to end with one another. Each top rail section 52 comprises an extruded profile in the form of a tubular member having a rectangular profile defining a horizontal top, a horizontal bottom and two sides extending between the top and bottom at laterally opposing sides of the beam. The top rail sections 52 are abutted end to end and each adjacent pair of the top rail sections are joined to one another by top coupling members 54. In the illustrated embodiment the top coupling members comprise plates mounted in pairs at each top junction between adjacent top rail sections so that the plates are parallel and spaced apart at laterally opposing sides to be abutted flat against inside surfaces of the opposing sides of the rectangular extruded profile of the top rail sections.

Each top coupling member 54 has a length which is approximately equal to the length of the top rail sections 52 and is centred relative to the respective top junction such that half of the overall length of each top coupling member overlaps each of the abutted top rail sections 52. Over the length of the overhead beam, the top coupling members 54 are similarly abutted end to end while being offset by half a length in the longitudinal direction relative to the top rail sections. The top coupling members 54 are fully received within the interior of the top rail sections and are fastened in fixed relation by threaded fasteners which extend from the exterior through the sides of the top rail sections for being threaded into respective threaded bores formed in the plates of the top coupling members 54. The top coupling members 54 thus bridge across the top junctions between top rail sections 52 while being fastened to the sides of the extruded profile of the top rail sections to stiffen the top rail sections against bending forces. The overall length of the top rail section and thus the overhead beam can be adjusted by varying the number of top rail sections and the corresponding number of top coupling members 54 connected between the top rail sections 52.

The bottom rail 44 is similarly formed of a plurality of bottom rail sections 56 which are mounted end to end with one another. Each bottom rail section 56 comprises an extruded profile which is generally C-shaped along its length so as to define a horizontal top, laterally opposed sides depending from opposing side edges of the top and two bottom flanges 58 extending horizontally inwardly towards one another to define the bottom. The bottom flanges 58 terminate spaced apart from one another so as to define a bottom gap between the bottom flanges extending along the full length of the bottom rail. The bottom rail sections 56 are abutted end to end, and each adjacent pair of the bottom rail sections are joined to one another by bottom coupling members 60. In the illustrated embodiment, the bottom coupling members 60 comprise plates mounted at each bottom junction between bottom rail sections so that one of the bottom coupling members 60 is provided in an upright orientation against each of the sides and an additional bottom coupling member 60 is provided horizontally against the top of the extruded profile at each of the bottom junctions.

Each bottom coupling member 60 has a length which is approximately equal to the length of the bottom rail sections 56 and is longitudinally centred relative to the respective bottom junction such that half of the overall length of each bottom coupling member overlaps each of the abutted bottom rail sections 56. Over the length of the overhead beam, the bottom coupling members 60 are similarly abutted end to end while being offset by half a length in the longitudinal direction relative to the bottom rail sections. The bottom coupling members are fully received within the interior of the bottom rail sections and are fastened in fixed relation by threaded fasteners which extend from the exterior through the sides and the top of the bottom rail sections for being threaded into respective threaded bores formed in the plates of the bottom coupling members 60. The bottom coupling members 60 thus bridge across the bottom junctions between bottom rail sections being fastened to the sides and top of the extruded profile of the bottom rail sections to stiffen the bottom rail sections against bending forces. The overall length of the bottom rail section can thus be adjusted together with the top rail section of the overhead beam by varying the number of bottom rail sections and the corresponding number of bottom coupling members connected between the bottom rail sections.

The mounting of the top coupling members 54 within the interior of the top rail sections and the mounting of the bottom coupling members 60 within the interior of the bottom rail sections ensures that at each abutted junction of rail sections, the exterior surface is flush and continuous across each junction. In addition, the bottom flanges 58 of the bottom rail sections are similarly aligned to be continuous and flush with one another across each junction by the combination of bottom coupling members engaged with sides and the top surfaces of the extruded profile to locate each bottom rail section 56 vertically and laterally relative to the next adjacent bottom rail section. In this manner, a continuous track is defined along the bottom of the bottom rail, accessed through the gap between the bottom flanges 58 along the length of the bottom rail through which suitable followers of the gate frame are received to suspend the gate frame for longitudinal sliding within the track defined in the bottom rail as described in further detail below.

The struts 46 comprise plate members which are mounted in laterally opposed pairs at longitudinally spaced positions along the length of the overhead beam 22. The plate members are elongated in a vertical direction and are mounted parallel against the exterior side surfaces of the top rail 42 and the bottom rail 44 of the beam. Threaded fasteners are penetrated from the exterior through the sides of the top and bottom rails for being threaded into corresponding threaded bores within the sides of the rails or the internal top coupling members 54 and bottom coupling members 60 respectively. Plural struts 46 are spaced apart along each of the top and bottom rail sections. Also, one pair of struts is aligned with each of the top and bottom junctions of the top and bottom rail sections. More particularly, at each junction, the plate member of the corresponding strut 46 is centred relative to the junction to overlap each of the adjacent rail sections so that one of the struts bridges each junction between adjacent rail sections to further strengthen the junction. In this manner, at each junction between abutted rail sections, the junction is reinforced internally by a pair of the top or bottom coupling members 54 or 60 and reinforced externally by a pair of the struts bridging the junction at both exterior side surfaces of the top and bottom rails.

The gate assembly further includes stationary fencing arranged to span the inner side of the gate assembly between the second post assembly 18 and the third post assembly 20. The stationary fencing includes a plurality of auxiliary posts 62 mounted at evenly spaced positions in the longitudinal direction within a common plane with the inside posts 24 of the post assemblies. The auxiliary posts 62 are similar in height to the inside posts of the post assembly and include base plates at the bottom in which the base plates are arranged to be secured by fastening to the upper surface of the foundation block 30. The stationary fencing further includes auxiliary rails 64 connected horizontally between the inside posts of the second and third post assemblies and the auxiliary posts 62 at various elevations including lowermost rail sections adjacent the bottom of the stationary fencing, uppermost rail sections adjacent the top of the stationary fencing, and intermediate rail sections at different elevations spaced between the top and bottom of the stationary fencing. A plurality of couplers 60 are provided at the junction of each of the rail sections of the auxiliary rails 64 with each of the inside posts 24 of the second and third post assemblies and the auxiliary posts 62 therebetween. The couplers 66 may comprise collars clamped about the posts with fastening flanges for securement to the rails. Fencing material such as chain-link fencing (not shown) may be mounted as a sheet fully spanning between the inside posts of the second and third post assemblies while being supported against the auxiliary posts 62 and auxiliary rails 64 of the stationary fencing structure.

The gate assembly further includes an angled upper fencing section fully spanning the top side of the gate assembly corresponding to the inside of the gate assembly in the illustrated embodiment. The upper fencing section includes a plurality of first angled posts 68 extending upwardly and laterally inwardly from each of the auxiliary posts 62 of the stationary fencing between the second and third post assemblies.

A similar set of second angled posts 70 extend upwardly and laterally inwardly from the top of the inside posts 24 of each post assembly at the same slope as the first angle posts 68. The second angled posts 70 are each mounted onto a suitable mounting bracket 72 for example by welding in which the mounting bracket is in turn secured by threaded fasteners to the top member 34 and the mounting blocks 40 of the intermediate members 38.

A set of third angled posts 74 are mounted onto the overhead beam at longitudinally spaced positions between the first post assembly and the second post assembly to span over the gate opening. Each third angled post extends upwardly at an inward slope similar to the slope of the first and second angled posts. Each third angled post 74 is mounted on a suitable bracket 76 in fixed relation thereto, for example by welding, in which the mounting bracket 76 is in turn mounted by threaded fasteners onto selected ones of the struts 46 at the inner side of the gate assembly.

A plurality of crossbars 78 are connected by suitable couplers between each adjacent pair of the angled posts 68, 70 and 74 along the length of the gate assembly so that crossbars are positioned in a continuous bottom row along the bottoms of the angled posts and in a continuous top row along the tops of the angled posts. Additional fencing material can then be secured to span between the angled posts 68, 70 and 74 such as longitudinally extending strands or helical coils of barbed wire or razor wire for example.

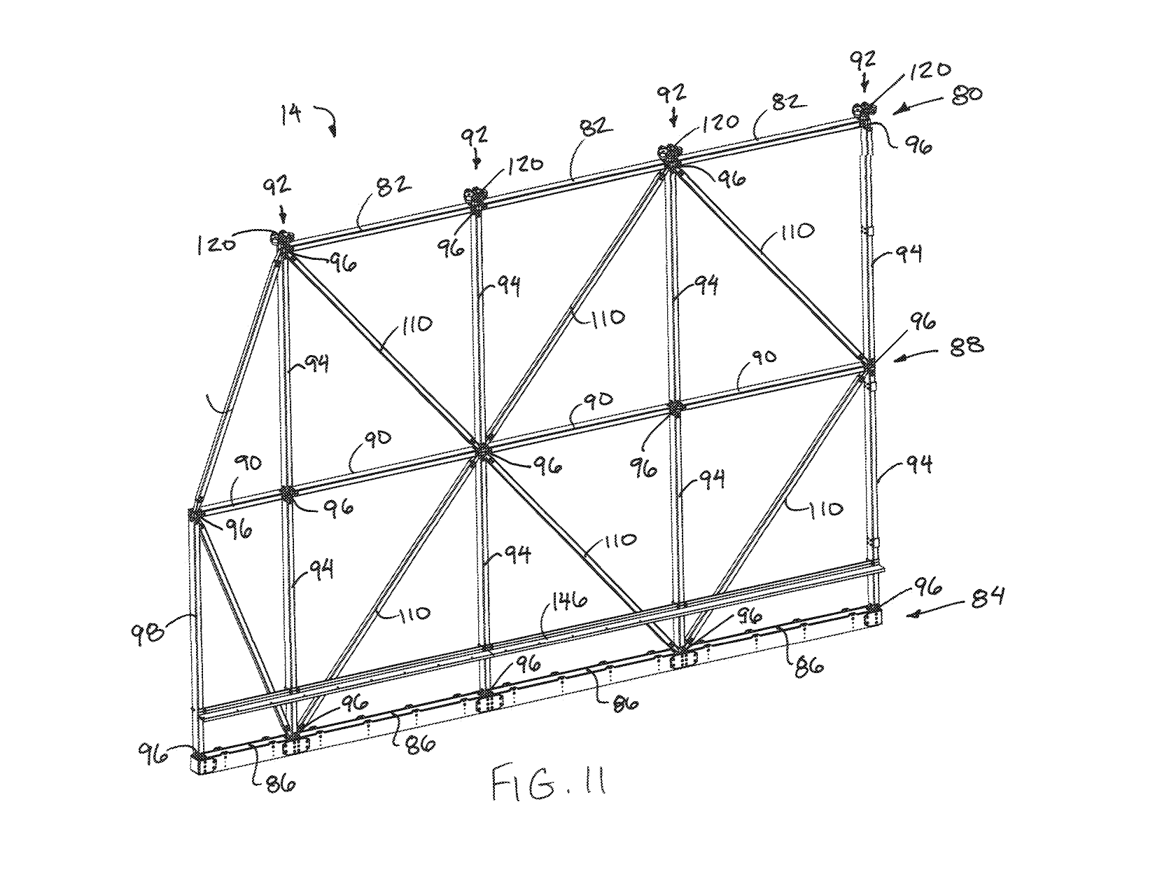

Turning now to the gate frame 14 shown in isolation in FIG. 11, the gate frame 14 also comprises a modular assembly of frame elements joined by threaded fasteners including (i) a top rail 80 formed of top rail sections 82 mounted longitudinally end to end with one another along the top of the gate frame, (ii) a bottom rail 84 formed of bottom rail sections 86 mounted longitudinally end to end with one another along the bottom of the gate frame, (iii) an intermediate rail 88 formed of intermediate rail sections 90 mounted longitudinally end to end with one another at an intermediate height between the top and bottom of the gate frame, (iv) posts 92 formed of post sections 94 mounted vertically end to end with one another across the height of the gate frame at respective longitudinally spaced positions including both ends of the gate frame, and (v) connectors 96 joining the rail sections to the post sections at each junction of a rectangular grid pattern of the frame elements.

Each of the top rail sections 82, the intermediate rail sections 90 and the bottom rail sections 86 comprise hollow tube members of rectangular profile along the length thereof in which the open ends of each rail section are joined to respective ones of the connectors 96 using threaded fasteners as described in further detail below. Each of the rail sections spans longitudinally between an adjacent pair of the posts 92. Similarly, each post section 94 spans between the top rail 80 and the intermediate rail 88 or between the intermediate rail 88 and the bottom rail 84.

In the illustrated embodiment, the gate frame includes three main sections in which each section is defined between an adjacent pair of posts spanning the full height of the gate frame such that the three main sections collectively span the full width of the gate opening in the closed position. One of the posts 92 spans a full height of the gate frame at a first end of the gate frame which aligns with the first post assembly in the closed position. Each of the intermediate rail 88 and the bottom rail 84 includes an additional rail section extending beyond the second end of the top rail in which the additional rail sections are joined by an auxiliary post section 98 connected between the intermediate rail 88 and the bottom rail 84 at the second end of the gate.

As noted above, one of the connectors 96 is provided at each of the intersections of one or more post sections 94 with one or more rail sections. Each connector 96 at each intersection or junction of the gate frame comprises a first member 100 at a first side of the gate frame and a second member 102 at a second side of the gate frame such that the first and second members are situated at laterally opposing sides of the gate frame with a gap in the lateral direction between the members.

Although various configurations of the connectors 96 are shown in the accompanying figures, the common features will first be described. Each connector includes a central block 104 at the exterior forming a respective shoulder 106 associated with each rail section or post section of the connector so that the corresponding end of the rail section or post section is abutted against the shoulder when connecting to the first member 100 or second member 102. Each connector further includes a leg 108 extending radially outward from the centre block in association with each shoulder 106 in which the leg 108 is longitudinally slidably received into the open end of the corresponding post section or rail section coupled to the leg. The leg is sized to be readily received within corresponding interior dimensions of the hollow post section or rail section mounted thereon. In the instance of a post section, the connector is provided with a vertical leg extending above or below the centre block 104 having a thickness in the longitudinal direction of the gate frame which can be received within the interior dimensions of the post section in the longitudinal direction. In the instance of a rail section, the connector is provided with a horizontal leg extending longitudinally from the centre block 104 having a thickness in the vertical direction which can be received within the interior dimensions of the rail section in the vertical direction.

When the end of the post section or rail section is abutted with the corresponding shoulder 106 of the centre block 104 and the legs 108 are positioned against the corresponding interior side surface of the post or rail section, fastener apertures in the ends of each post section or rail section are aligned with threaded bores formed at spaced positions along each leg 108 such that threaded fasteners can be inserted from the exterior through the fastener apertures in the ends of the post and rail sections into the respective legs for securely fastening each leg relative to the corresponding post section and rail section. The fasteners provide proper alignment of each leg with the corresponding post or rail section.

In the instance of one of the perimeter corners of the gate frame, the corresponding connector 96 is a corner connector in which both the first member 100 and the second member 102 of the connector has a single vertical leg inserted into the corresponding post section extending above or below the centre block 104 and a single horizontal leg inserted into the corresponding rail section extending longitudinally from the centre block.

At the first end of the gate frame, the corresponding connector 96 is an end connector in which both the first member 100 and the second member 102 have vertical legs extending both above and below the centre block for being inserted into corresponding post sections above and below the centre block, while a single horizontal leg is inserted into the corresponding rail section of the intermediate rail extending longitudinally from the centre block.

Along each of the top and bottom rails of the gate frame, each top junction between adjacent top rail sections and each bottom junction between adjacent bottom rail sections is provided with a corresponding connector 96 in the form of a top or bottom connector in which both the first member 100 and the second member 102 of the connector have a single vertical leg extending either above or below the centre block for mounting to the corresponding post section and two horizontal legs extending in longitudinally opposing directions from the centre block for being inserted into the corresponding rail sections of the top or bottom rail.

At each intermediate junction between adjacent intermediate rail sections of the intermediate rail, the corresponding connector 96 is an intermediate connector. In the instance of an intermediate connector, both the first member 100 and the second member 102 of each connector has two vertical legs extending above and below the centre block for mounting into the corresponding post sections above and below the connector, and two horizontal legs extending in longitudinally opposing directions from the centre block for being inserted into the corresponding rail sections of the intermediate rail of the gate frame.

The gate frame 14 also includes a plurality of diagonal struts 110 mounted diagonally across respective rectangular sections of the rectangular grid of the gate frame formed by the post sections and rail sections described above. Each diagonal strut 110 is thus mounted to extend transversely at an angle to both the post sections and the rail sections between two of the connectors 96 at diagonally opposed corners of a rectangular section of the gate frame. Each strut 110 is a hollow tubular member having a strut mount 112 mounted at each of the opposing ends. The strut mount 112 includes a leg 114 slidably inserted into the open ends of the tubular member forming the diagonal strut 110. Fasteners are penetrated through the wall of the diagonal struts and into corresponding threaded bores in the leg 114 at longitudinally spaced positions along the length of the strut to secure each strut mount 112 in fixed relation to the corresponding end of the diagonal strut 110. The strut mount 112 protrudes from the end of the tubular member of the diagonal strut 110 to a tapered end portion 116 having a thickness in the lateral direction of the gate frame which occupies the gap between the first member 100 and second member 102 of each gate frame connector 96.

The tapered end portion 116 includes a mounting bore extending in the lateral direction the gate frame therethrough for mounting onto a corresponding pivot shaft 118 of the connector 96 onto which the diagonal strut is mounted. More particularly, each of the connectors 96 includes between one and four pivot shafts 118 spanning in the lateral direction between respective mounting bores formed in the first member 100 and the second member 102. The mounting bore in the tapered end portion 116 at each end of each strut receives a corresponding pivot shaft 118 therethrough such that the pivot shaft is pivotal about the pivot shaft to vary the angular orientation of the diagonal strut relative to the connectors 96 at opposing ends upon which the diagonal strut is mounted.

The angle of the diagonal strut is only pivotally adjusted when assembling the gate frame and the length of the post sections in the rail sections are being initially selected. The gate assembly may be provided with a plurality of auxiliary rail sections (not shown) similar to the rail sections 82, 86, and 90 described above but different in length, in which the auxiliary rail sections can be interchanged with the rail sections 82, 86 and 90 to vary the overall length of the gate frame. Similarly auxiliary post sections (not shown) having similar configuration but different length compared to the post sections 94 described above can be interchanged with the post sections 94 to vary the overall height of the gate frame. When either of the post sections or rail sections are varied in length, the corresponding diagonal dimensions of each rectangular section of the gate frame may vary such that the diagonal struts can similarly be interchanged with different tubular members of different length mounted on the same strut mounts 112 which are mounted in the same manner on respective pivot shafts of the connectors 96.

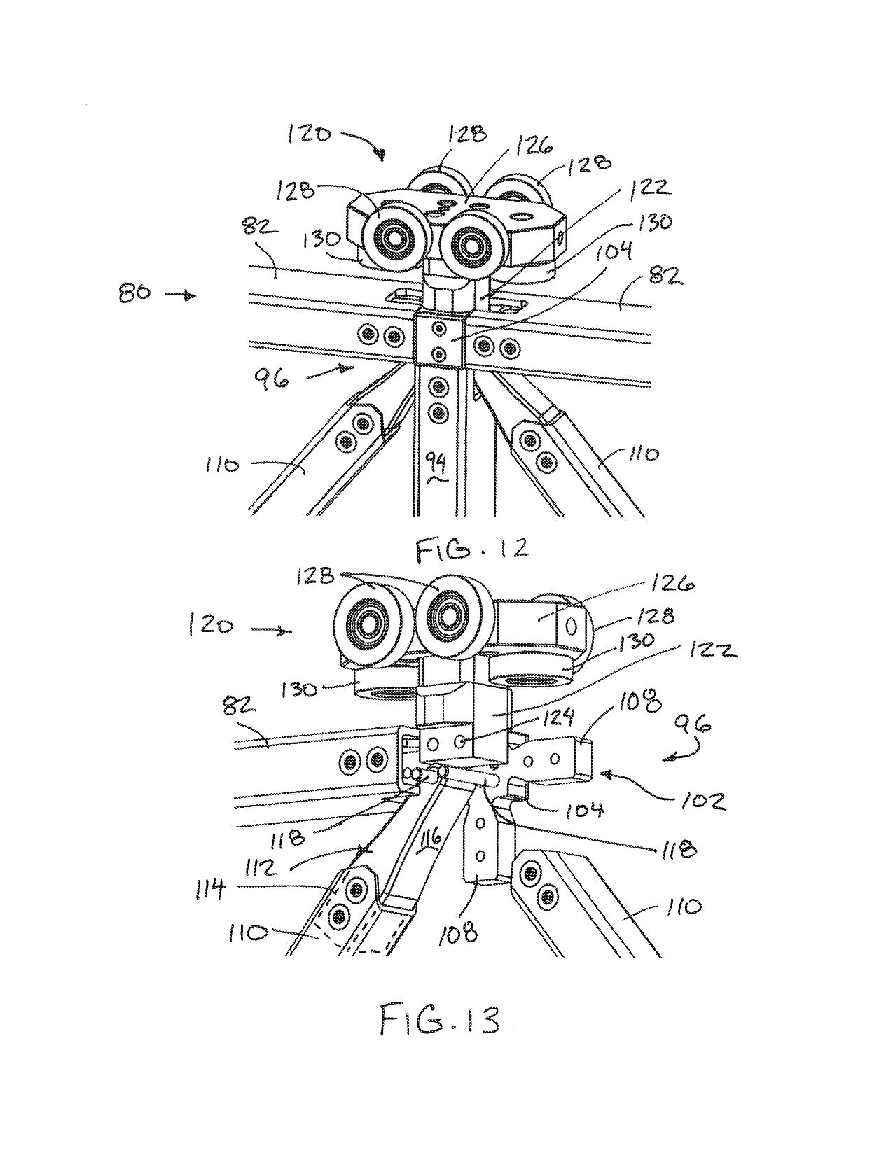

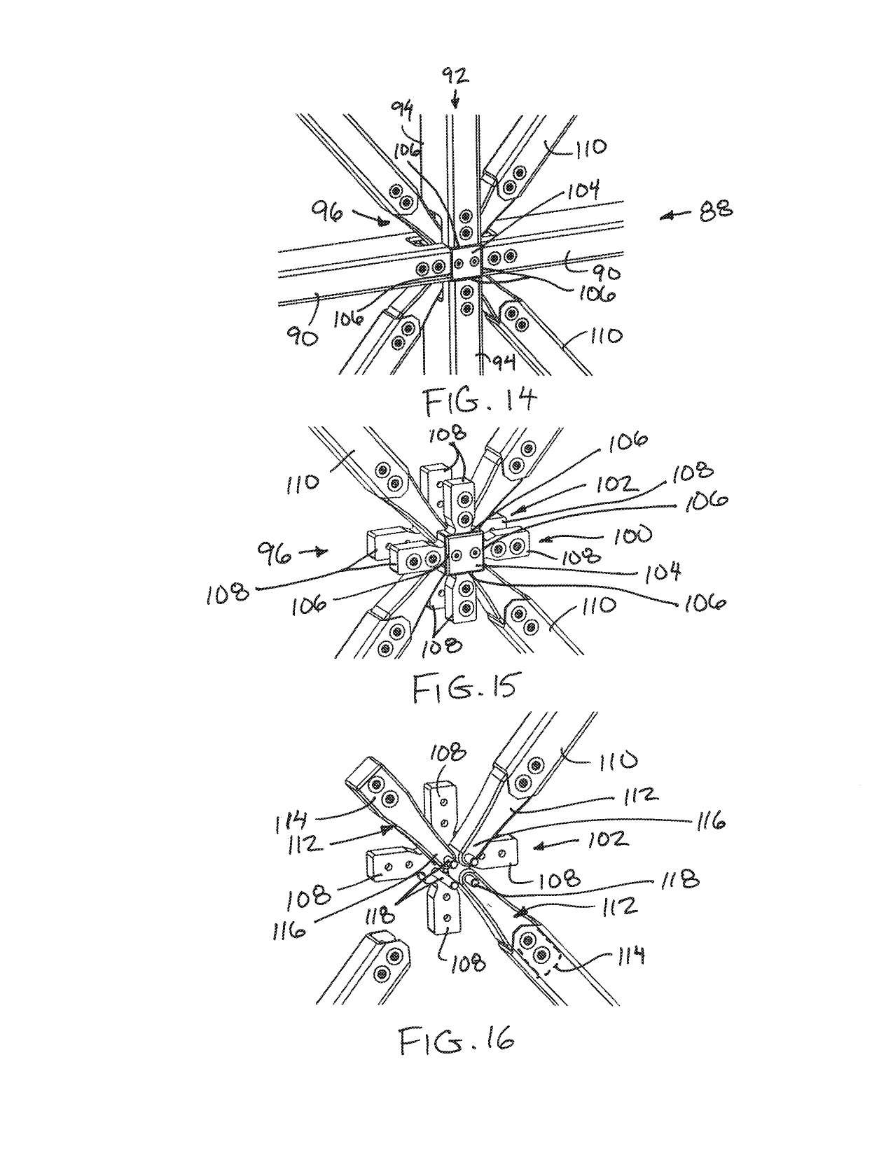

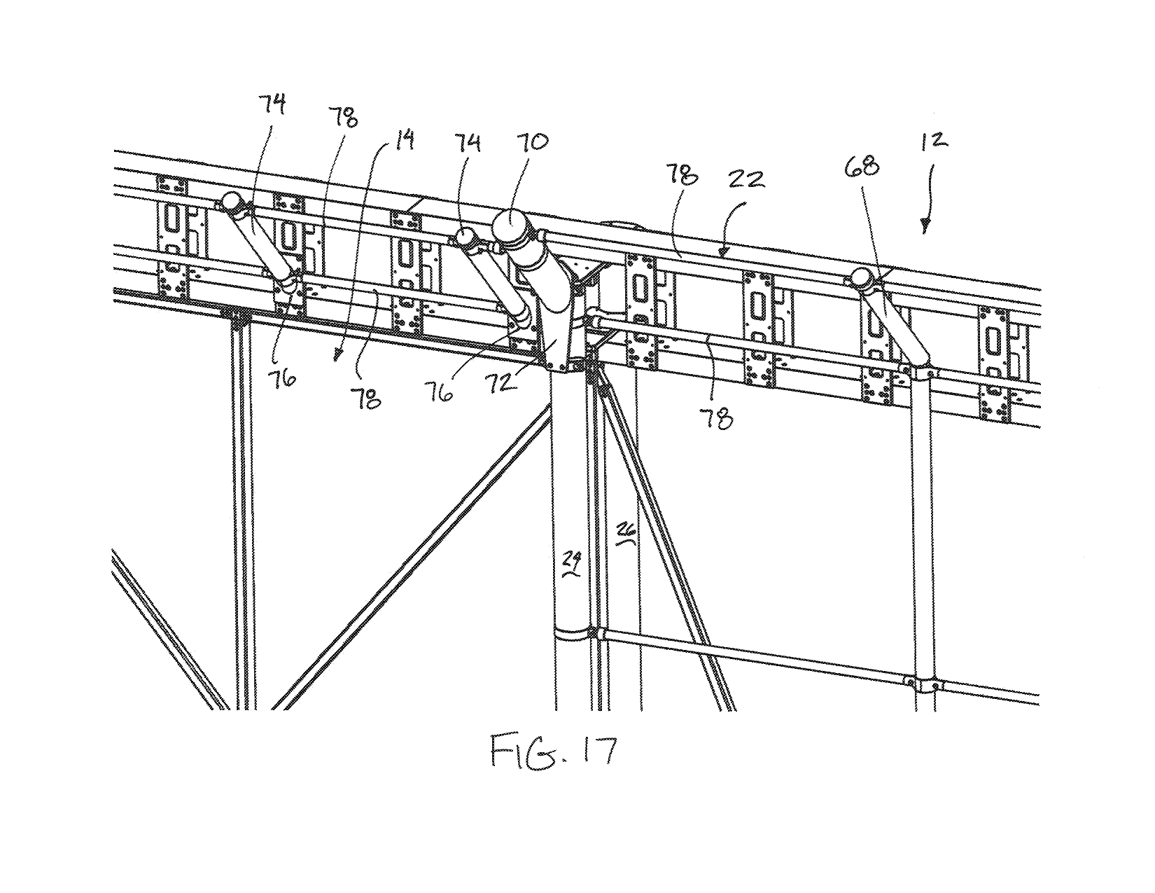

In the instance of connectors 96 at the corners of the gate frame, only a single pivot shaft 118 is mounted between the centre blocks 104 of the first member 100 and the second member 102 for optional mounting of a single diagonal strut to that connector. In the instance of a connector at an intermediate location along the top rail or the bottom rail, the connector 96 is provided with two pivot shafts 118 as shown in FIG. 13 to enable to diagonal struts 110 to be optionally mounted to extend from longitudinally opposing sides. Connectors 96 at the opposing ends of the intermediate rail of the gate frame are similarly provided with two pivot shafts 118 for optionally connecting to diagonal struts 110 thereon. The connectors 96 at intermediate locations along the intermediate rail are each provided with four pivot shafts for optionally mounting up to four diagonal struts 110 as best shown in FIGS. 14 through 16.

Once diagonal struts have been mounted between corresponding connectors 96 of the gate frame, some or all of the rectangular sections of the gate frame are effectively subdivided into triangular sections to maintain the square orientation of the post sections relative to the rail sections at each junction.

One of the diagonal struts 110 is mounted between the end of the top rail and the end of the intermediate rail 88 that extends longitudinally beyond the top rail so that the extension post section 98 and one of the diagonal struts collectively form the terminal end of the gate frame at the second end thereof.

The connectors 96 at the top of each post 92 of the gate frame, corresponding to each top junction between adjacent top rail sections 82, and at each of the opposing ends of the top rail 80, also serve to mount top roller carriages 120 thereon. Each top roller carriage 120 supports a plurality of rollers thereon arranged to be received inside the track defined within the hollow interior of the bottom rail 44 of the overhead beam 22 such that the top roller carriages 120 collectively suspend the gate frame from the overhead beam while supporting the gate frame for translating movement between the open and closed positions described above.

Each top roller carriage 120 includes a mounting leg 122 arranged to be received between the first member 100 and the second member 102 of the corresponding connector 96. A pair of mounting bores 124 extend in the lateral direction through the bottom of the mounting leg for alignment with a corresponding pair of mounting shafts that are mounted between the centre blocks 104 of the first member 100 and the second member 102 similarly to the pivot shafts 118. Receiving mounting shafts extending through the bores 124 of the mounting leg 122, while the mounting leg occupies the gap between the first member 100 and the second member 102, is sufficient to mount the leg 122 in fixed relation to the corresponding connector 96. The mounting leg extends above the top rail of the mounting frame and is suitably dimensioned to be received extending upwardly through the gap between the bottom flanges 58 at the bottom of the bottom rail 44 of the overhead beam.

Each top roller carriage 120 further includes a carriage body 126 mounted at the top end of the mounting leg 124 to support the various rollers of the roller cage thereon. The rollers include two longitudinally spaced side rollers 128 rotatably mounted at each of the two laterally opposing sides of the carriage body such that the rollers at the opposing sides of the carriage body are aligned for rolling engagement upon inside surfaces of the two bottom flanges 58 of the bottom rail respectively. The rollers on each carriage body further include two bottom rollers 130 supported for rotation about vertical axes at longitudinally spaced positions on the bottom of the carriage body for alignment with the gap between the flanges 58. The side rollers 128 are rotatable about respective axes oriented in the lateral direction for rolling movement along the bottom flanges as the gate frame is displaced between open and closed positions. The bottom rollers 130 are only slightly undersized relative to the lateral dimension of the gap such that the bottom rollers provide centering in the lateral direction of the carriage body relative to the bottom rail within which the carriage body is received to maintain alignment of the side rollers with the bottom flanges.

At the bottom of the gate frame, the bottom rail 84 is further provided with a pair of side plates 132 extending alongside the bottom rail at laterally opposing sides thereof to span the full length of the gate frame. The side plates 132 are formed in sections mounted end to end with one another in the longitudinal direction similarly to the bottom rail sections 86. The side plates are secured to the bottom rail with threaded fasteners penetrated into the side plates and threaded into respective threaded bores formed in opposing side surfaces of the bottom rail. The side plates are oriented such that the each protrude below the bottom rail by an equal distance so as to define a bottom roller channel 134 between the side plates that is open to the bottom of the gate frame along the full length of the gate frame. At the junction of each adjacent pair of sections of the side plates at both sides of the gate frame, additional junction plates 136 are provided. Each junction plate is mounted to an external side surface of the side plates 132 to bridge across an abutted junction of two adjacent sections of the side plates in which threaded fasteners are penetrated through the junction plates 136 into each of the sections of the side plates being bridged by the junction plate. In this manner sections of the side plates 132 are secured in fixed relation to one another while maintaining a flush interior side surface along both interior side walls of the bottom roller channel 134.

The bottom roller channel receives a pair of bottom roller guides 138 therein. The bottom roller guides 138, described in further detail below, provide alignment of the gate frame with components of the drive housing 140 in a lateral direction of the gate assembly.

The drive housing 140 in the illustrated embodiment is mounted at the second side of the gate assembly corresponding to an outside of the gate assembly when the stationary fencing and the angled upper fencing section are mounted at the opposing inside of the gate assembly. The drive housing is supported on a base plate 142 arranged to be mounted flat against the upper surface of the foundation block 30 using suitable embedded anchors that are embedded in the foundation block and protrude upwardly through fastener openings in the base plate to enable the base plate to be fastened in fixed relation to the foundation block.

The drive housing 140 extends upwardly from the base plate and houses an internal drive motor with a rotary output in the form of an output gear driven to rotate about an axis oriented in the lateral direction of the gate assembly at one side of the drive housing nearest to the gate frame. The output gear of the drive housing cooperates with a rack 144 mounted on the gate frame. More particularly, the rack comprises a row of gear teeth at longitudinally spaced positions along an elongate frame member 146 that is mounted on the second side of the gate frame corresponding to the same outer side where the drive housing 140 is located. The elongate frame member 146 is formed in longitudinal sections mounted end to end with one another and which span across the posts 92 at a location spaced above the bottom rail 84, using threaded fasteners penetrated through the frame member 46 for securement to the posts 92 to fix the frame member relative to the posts. The drive housing 140 includes a slotted passage 148 extending through the housing in alignment with the frame member 46 so that the output gear driven to rotate by the drive housing can mesh with the teeth formed on the frame member 146 to define the rack 144 on the gate frame. In this manner, using the motor to rotate the output gear of the drive housing 140 in opposing first and second directions results in the gate frame being driven linearly in opposing opening or closing directions to open or close the gate assembly.

Each bottom roller guide 138 is mounted on either the base plate 142 of the drive housing or the base plate 28 of the second post assembly so that the two bottom roller guides are longitudinally spaced apart from one another adjacent longitudinally oppose sides of the drive housing 140 while being received within the bottom channel 134 of the gate frame at longitudinally spaced positions. Each bottom roller guide 138 includes a rocker member 150 supporting a pair of bottom rollers 152 at opposing ends thereof such that the bottom rollers are rotatable about respective vertical axes. The rocker member is pivotal relative to the base plate 142 using a central pivot 154 at an intermediate location spaced from each of the bottom rollers 152 at an intermediate location therebetween so that the rocker member is pivotal about a vertical pivot axis. The rocker member extends generally in the longitudinal direction of the gate assembly between the bottom rollers 152 at opposing ends thereof such that pivoting of the rocker member effectively adjusts the overall width defined by the two rollers in the lateral direction. An adjustment member 156 is provided in the form of a screw that is threaded into a mounting block 158 mounted in fixed relation to the base plates 142 or 28 adjacent to the rocker member. The screw protrudes from the block 158 for engaging the rocker member 150 at a location radially offset from the central pivot 154 so that rotating the screw in a first direction acts to engage the rocker member and urge rotation of the rocker member in a direction that increases the overall width occupied by the two bottom rollers in the lateral direction. In this manner the width occupied by the bottom rollers can be accurately controlled to fill the width of the bottom roller channel 134 at the bottom of the gate frame to minimize any tolerance in the lateral direction of the gate frame relative to the drive housing. This in turn ensures that the rack on the gate frame is aligned in the lateral direction with the output gear on the drive housing.

To assist in aligning the gate frame with the gap between the inside post 24 and the outside post 26 of the third post assembly 20 as the gate frame is displaced towards the open position, the third post assembly includes a gate guide 160 mounted thereon at an intermediate height between the top and bottom ends of the post assembly. The gate guide 160 includes a guide member 162 mounted on interior side of each of the posts using a clamp member 164 secured at the exterior side of each of the posts. Fasteners extend in the lateral direction between each guide member 162 and the corresponding clamp member 164 for clamping in fixed relation about the post. Each guide member includes an inner guide surface 166 formed thereon such that the pair of guide surfaces are sloped laterally inwardly towards one another while extending in the longitudinal direction corresponding to the opening direction of the gate frame. In this manner, any lateral misalignment of the gate frame from a centred position between the posts of the third post assembly will result in the second end of the gate frame engaging one of the guide surfaces 166 to redirect the gate frame laterally inwardly to the centred position between the guide members as the gate frame approaches the fully open position. The guide surfaces 166 may comprise a replaceable member mounted along the corresponding edge of the guide member 162 to minimize wear or to allow the guide surface to be interchanged when worn.

Similarly to the third post assembly, the first post assembly 16 is provided with a structure to laterally centre the first end of the gate frame relative to the inside post 24 and the outside post 26 of the first post assembly when the gate is closed. In this instance a set of three gate receiving sockets 168 are provided at vertically spaced positions along the first post assembly between the top and bottom ends thereof. Each gate receiving socket 168 is defined on a respective crossmember 170 in the form of a horizontal plate mounted to span the gap between the inside post 24 and the outside post 26. The laterally opposing ends of each crossmember are each secured relative to the respective post using a pair of clamp members 172 which are clamped against laterally opposing sides of the respective post using laterally extending fasteners secured between the clamp members 172. Opposing ends of the crossmember 170 are mounted onto the innermost clamp members 172 to fix the crossmember relative to the posts.

Each gate receiving socket 168 is formed as a recess along one edge of the crossmember 170. The profile of the recess includes an inner portion 174 defining a pair of parallel walls that are parallel to the plane of the gate opening and laterally spaced apart from one another by a distance that closely fits the corresponding width of the gate frame therebetween. The recess within each crossmember 170 also includes an outer portion 176 in which the laterally opposing boundaries of the socket define tapered guide walls which diverge away from one another in the lateral direction while extending in the longitudinal direction in the opening direction of the gate frame. Accordingly, the tapered guide walls of the outer portion 176 are sloped and tapered inwardly towards one another in the closing direction, corresponding to the first end or terminal end of the gate frame approaching the sockets as the gate is closed. In the event that the gate frame is misaligned in the lateral direction from a centred position between the inside post and the outside post, the end of the gate frame will engage the corresponding tapered guide wall 176 which redirects the gate frame in the lateral direction back to a centred position in alignment with the parallel walls of the inner portion 174 of the socket as the gate approaches the fully closed position. Once in the fully closed position, the gate frame is prevented from being displaced in the lateral direction at the first end of the gate frame by the end post of the gate frame being snugly received between the parallel walls of the inner portion 174 of each of the gate receiving sockets 168.

The end post at the first end of the gate frame may further be provided with a wear member 178 overlapping the corresponding exterior surfaces of the end post in alignment with each gate receiving socket 168. The wear member may be a bolt on plate extending along exterior side surfaces and the end surface of the gate to form a point of engagement of the gate frame with either of the tapered guide walls of the outer portion 176 of the gate receiving socket. The wear member 178 may be formed of a suitable material that minimizes friction and/or wear, or that is readily replaceable when it does become worn, to maintain a close tolerance of the gate frame between the parallel walls of the inner portion 174 the gate receiving sockets in the lateral direction in the closed position.

A suitable sheet of fencing material, for example chain-link fencing is further mounted to span the first side or inner side of the gate frame by being secured with suitable ties or clamps secured to the post sections and rail sections of the gate frame. The side plates 132 extending along the bottom rails at each side of the gate frame may be manufactured with mounting eyelets 180 at longitudinally spaced locations along the top edge of the side plate that protrude above the top side of the bottom rail of the gate frame. The eyelets 180 provide a mounting location to receive ties for securing the fencing material to the bottom rail along the bottom perimeter edge of the gate frame.

Since various modifications can be made in the invention as herein above described, and many apparently widely different embodiments of same made, it is intended that all matter contained in the accompanying specification shall be interpreted as illustrative only and not in a limiting sense.

1. A gate assembly comprising:
a first post assembly and a second post assembly arranged to be supported in fixed relation to ground at longitudinally spaced apart locations so as to define a gate opening spanning in a longitudinal direction between the first post assembly and the second post assembly;
an overhead beam arranged to be mounted on the first post assembly and the second post assembly so as to span in the longitudinal direction over the gate opening; and
a gate frame arranged to be suspended from the overhead beam for translating movement in the longitudinal direction along the overhead beam between a closed position spanning the gate opening between the first post assembly and the second post assembly and an open position in which the gate opening is at least partially unobstructed by the gate frame;
wherein at least one of the overhead beam and the gate frame comprises a modular assembly of frame elements joined to one another by threaded fasteners whereby the modular assembly is reduced in length in the longitudinal direction when the frame elements are disassembled relative to one another.

2. The gate assembly according to claim 1 wherein the overhead beam comprises said modular assembly and the frame elements comprise (i) a top rail formed in top rail sections mounted longitudinally end to end, (ii) a bottom rail formed in bottom rail sections mounted longitudinally end to end, and (iii) a plurality of struts fastened between the top rail and the bottom rail.

3. The gate assembly according to claim 2 wherein the struts of the overhead beam comprise plate members mounted externally at opposing sides of the top rail and the bottom rail at longitudinally spaced positions.

4. The gate assembly according to claim 3 wherein each adjacent pair of the top rail sections forms a top rail junction, wherein each adjacent pair of the bottom rail sections forms a bottom rail junction, and wherein the top rails sections of each top rail junction and the bottom rail sections of each bottom rail junction are joined by a pair of the plate members forming the struts which span across the top rail junction and the bottom rail junction.

5. The gate assembly according to claim 2 further comprising at least one top coupling member joined between each adjacent pair of the top rail sections so as to longitudinally overlap each of the top rail sections of the adjacent pair, and at least one bottom coupling member joined between each adjacent pair of the bottom rail sections so as to longitudinally overlap each of the bottom rail sections of the adjacent pair.

6. The gate assembly according to claim 1 wherein each of the top rail sections and bottom rail sections is an extruded profile, wherein said at least one top coupling member comprises a pair of plate members mounted parallel and spaced apart from one another at laterally opposing sides of the top rail sections, and wherein said at least one bottom coupling member comprises a pair of plate members mounted parallel and spaced apart from one another at laterally opposing sides of the bottom rail sections.

7. The gate assembly according to claim 1 wherein the plate members forming the top and bottom coupling members are mounted internally within the extruded profiles of the top rail sections and bottom rail sections.

8. The gate assembly according to claim 1 wherein the gate frame comprises said modular assembly and the frame elements comprise (i) a top rail formed in top rail sections mounted longitudinally end to end, (ii) a bottom rail formed in bottom rail sections mounted longitudinally end to end, (iii) an intermediate rail formed in intermediate rail sections mounted longitudinally end to end, (iv) a plurality of posts formed in post sections mounted vertically end to end, and (v) a plurality of gate connectors mounted at respective junctions of the post sections with the rail sections.

9. The gate assembly according to claim 8 wherein each post section and each rail section of the gate frame comprises a tubular member, and wherein each gate connector includes (i) at least one post leg arranged to be vertically slidable into the tubular member of a respective one of the post sections and (ii) at least one rail leg arranged to be longitudinally slidable into the tubular member of a respective one of the rail sections.

10. The gate assembly according to claim 8 further comprising a plurality of auxiliary rail sections different in length from the top rail sections, the bottom rail sections and the intermediate rail sections, in which the auxiliary rail sections are interchangeable with the top rail sections, the bottom rail sections and the intermediate rail sections.

11. The gate assembly according to claim 8 wherein the gate frame further comprises a plurality of diagonal struts connected between respective ones of the gate connectors, the diagonal struts extending transversely to the post sections and the rail sections.

12. The gate assembly according to claim 11 wherein the diagonal struts are connected to the respective gate connectors by pivotal connections such that an angular orientation of each diagonal strut relative to the post sections is adjustable according to a selected length of the rail sections.

13. The gate assembly according to claim 11 wherein each post section and each rail section of the gate frame comprises a tubular member, wherein the gate frame further comprises a plurality of diagonal struts connected between respective ones of the gate connectors, and wherein some of the gate connectors comprises intermediate gate connectors, each intermediate gate connector comprising:
(i) two post legs arranged to be vertically slidable into the tubular members of two post sections above and below the intermediate gate connector respectively;
(ii) two rail legs arranged to be longitudinally slidable into the tubular members of two rail sections at longitudinally opposed sides of the intermediate gate connector; and
(iii) four pivotal connections pivotally coupling respective ones of the diagonal struts thereon to extend transversely to the post and rail sections at circumferentially spaced locations about the intermediate gate connector.

14. The gate assembly according to claim 8 wherein the bottom rail sections comprise tubular members and wherein the bottom rail further comprises a pair of side plates mounted along laterally opposing sides of the tubular members so as to define a bottom roller channel along a bottom side of the bottom rail, the bottom roller channel receiving at least one bottom roller rotatable therein.

15. The gate assembly according to claim 8 further comprising at least one bottom roller guide arranged to be received within a bottom roller channel extending along a bottom side of the gate frame, said at least one bottom roller guide comprising:
a rocker member pivotally supported about an upright pivot axis;
a pair of bottom rollers supported for rotation about respective upright roller axes at opposing ends of the rocker member;
an adjustment member arranged to urge pivotal rotation of the rocker member in direction to increase an overall width defined by the pair of bottom rollers in a lateral direction transversely to the longitudinal direction of the gate frame.

16. The gate assembly according to claim 8 wherein the gate frame further comprises a top roller carriage supported at each junction between adjacent ones of the top rail sections, each top roller carriage being supported in rolling engagement along the overhead beam.

17. The gate assembly according to claim 1 wherein the first post assembly receives a terminal end of the gate frame engaged thereon in the closed position of the gate, the first post assembly including a plurality of gate receiving sockets formed thereon at vertically spaced locations, each gate receiving socket including a pair of parallel socket walls receiving the gate frame therebetween and a pair of tapered guide walls sloped laterally inwardly towards one another and towards the parallel socket walls so to be arranged to guide the gate frame between the parallel socket walls as the gate frame is displaced towards the closed position.

18. The gate assembly according to claim 17 wherein the gate frame comprises an end post at the terminal end of the gate frame and arranged to be received within the gate receiving sockets, the end post further comprising wear members covering the end post and engaging the parallel socket walls and the tapered guide walls of the gate receiving sockets in the closed position.
